(19) United States
(12) Patent Application Publication
(10) Pub. No.: US 2012/0267354 A1
(43) Pub. Date: Oct. 25, 2012

(54) RADIANT HEATING SYSTEM FOR VEHICULAR USE

(75) Inventors: Asami Okamoto, Kariya-city (JP); Manabu Maeda, Nagoya-city (JP); Koji Ota, Kariya-city (JP)

(73) Assignee: DENSO CORPORATION, Kariya-city (JP)

(21) Appl. No.: 13/454,496

(22) Filed: Apr. 24, 2012

(30) Foreign Application Priority Data
Apr. 25, 2011 (JP) 2011-096777

(51) Int. Cl. B60L 1/02

(52) U.S. Cl. 219/202

(57) ABSTRACT

A radiant heating system for vehicular use which is attached to an interior member of a passenger compartment, has a heating means for generating radiant heat, a protective member which is arranged at a passenger compartment side from the heating means and which prevents a driver from contacting the heating means, and supporting members which support the protective member, wherein the front surface of the protective member is provided with a plurality of projecting members, the supporting members are provided so as to form an air space at an opposite side of the protective member from the compartment side, the protective member flexes when the driver pushes against one of the projecting members, projecting members which adjoin the pushed member tilt to the pushed member side, and the distances between the front ends of the pushed projecting member and the adjoining projecting members become smaller.

### BACKGROUND OF THE INVENTION

1. Field of the Invention

The present invention relates to a radiant heating system for vehicular use which uses radiant heat to heat the inside of a passenger compartment.

2. Description of the Related Art Japanese Patent Publication (A) No. 2010-52710 discloses a radiant heating system for vehicular use which is provided with a flat electric heater which is arranged along a surface of an interior member inside a passenger compartment, a protective member which is arranged at a front surface of the electric heater, and a supporting member which is arranged at a back surface of the electric heater.

A radiant heating system for vehicular use of Japanese Patent Publication (A) No. 2010-52710 lowers the thermal conductivity of the supporting member from the thermal conductivity of the protective member to thereby suppress heat transfer from the heating system to the supporting member and efficiently conduct heat to the protective member side, that is, the inside of the passenger compartment.

### SUMMARY OF THE INVENTION

However, in the radiant heating system for vehicular use of Japanese Patent Publication (A) No. 2010-52710, the surface temperature of the protective member of the heating system easily rises, so there is the problem that the driver etc. might contact the raised surface temperature protective member and be burned.

Therefore, the present invention seeks to solve this problem and provide a radiant heating system for vehicular use which is structured to make it difficult for the driver etc. to contact a raised surface temperature protective member and thereby prevents the driver etc. from being burned.

A first aspect of the present invention provides a radiant heating system for vehicular use which is attached to an interior member which forms an inside surface of a passenger compartment, the radiant heating system for vehicular use comprising a heating means for generating radiant heat, a protective member which is arranged at a passenger compartment side from the heating means and which prevents the driver etc. from contacting the heating means, and supporting members which support a location of the protective member at an opposite side from the inside of the passenger compartment, wherein the front surface of the protective member at the passenger compartment side is provided with a plurality of projecting members, the protective member has pliability, the supporting members are provided so as to form an air space at an opposite side of the protective member from the passenger compartment side, the protective member flexes in a pushed direction when the driver etc. pushes against one of the projecting members, projecting members which adjoin the pushed projecting member tilt to the pushed projecting member side, and the distances between the front end of the pushed projecting member and the front ends of the adjoining projecting member become smaller.

According to this configuration, since the front surface of the protective member at the passenger compartment side is provided with a plurality of projecting members, heat of the heating means is radiated from the front surface of the protective member between projecting members.

If the driver etc. pushes a certain specific projecting member, the protective member is acted upon by a force in the pushing direction and the protective member flexes in this pushing direction. Due to this, the projecting members which adjoin the pushed projecting member tilt to the pushed projecting member side. Due to this, the distances between the front end of the pushed projecting member and the front ends of the adjoining projecting members become smaller and it becomes harder for the driver etc. to contact the protective member raised in temperature.

Due to such an action, it is possible to prevent burns etc. without causing a drop in the sense of the driver etc. of being heated.

A second aspect of the present invention provides a radiant heating system for vehicular use which is attached to an interior member which forms an inside surface of a passenger compartment, the radiant heating system for vehicular use comprising a heating means for generating radiant heat, a protective member which is arranged at a passenger compartment side from the heating means and which prevents a driver etc. from contacting the heating means, and a supporting member which supports a location of the protective member at an opposite side from the inside of the passenger compartment, wherein the front surface of the protective member at the passenger compartment side is provided with a plurality of projecting members, the protective member and supporting member have pliability, the protective member and the supporting member flex in a pushed direction when the driver etc. pushes against on of the projecting members, projecting members which adjoin the pushed projecting member tilt to the pushed projecting member side, and the distances between the front end of the pushed projecting member and the front ends of the adjoining projecting members become smaller.

According to this configuration, the front surface of the protective member at the passenger compartment side is provided with a plurality of projecting members, so heat of the heating means is radiated into the passenger compartment from the front surface of the protective member between projecting members.

If the driver etc. pushes against a certain specific projecting member, the protective member and supporting member are acted on by a force in the pushing direction and the protective member and supporting member flex in this pushing direction. Due to this, projecting members which adjoin the pushed projecting member tilt to the pushed projecting member side. Due to this, the distances between the front end of the pushed projecting member and the front ends of the adjoining projecting members become smaller and it becomes harder for the driver etc. to contact the raised temperature protective member.

Due to such an action, advantageous effects similar to the first aspect of the present invention can be exhibited.

In the present invention, the radiant heating system for vehicular use may have a pair of sheet-shaped members which have pliability, the protective member may be comprised by one of the pair of sheet-shaped members, the front surface of this one sheet-shaped member may be provided with the projecting members, and the heating means may be provided between the pair of sheet-shaped members.

### BRIEF DESCRIPTION OF THE DRAWINGS

The present invention may be more fully understood from the description of preferred embodiments of the invention, as set forth below, together with the accompanying drawings, wherein:

FIG. 1 is a schematic view which shows the state of attachment of a radiant heating system for vehicular use according to a first embodiment to a vehicle;

FIG. 2A is a plan view which shows a part of the radiant heating system for vehicular use according to the first embodiment;

FIG. 2B is a cross-sectional view along the line I-I in FIG. 2A;

FIG. 3 is a cross-sectional view which shows the state of the radiant heating system for vehicular use according to the first embodiment being pushed;

FIG. 4A is a plan view which shows a part of a radiant heating system for vehicular use according to a second embodiment; and

FIG. 4B is a cross-sectional view along the line II-II in FIG. 4A.

### DESCRIPTION OF THE PREFERRED EMBODIMENTS

### First Embodiment

Constitution of Present Embodiment

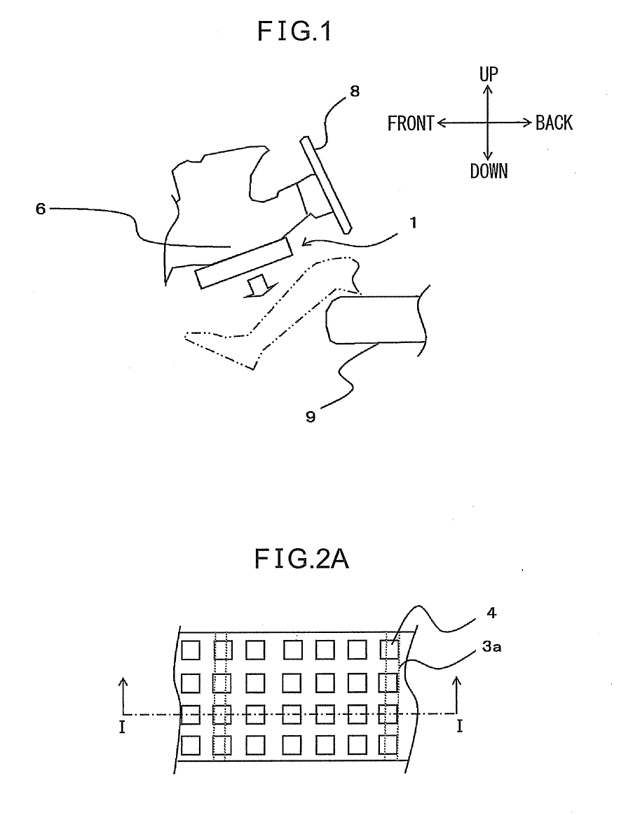

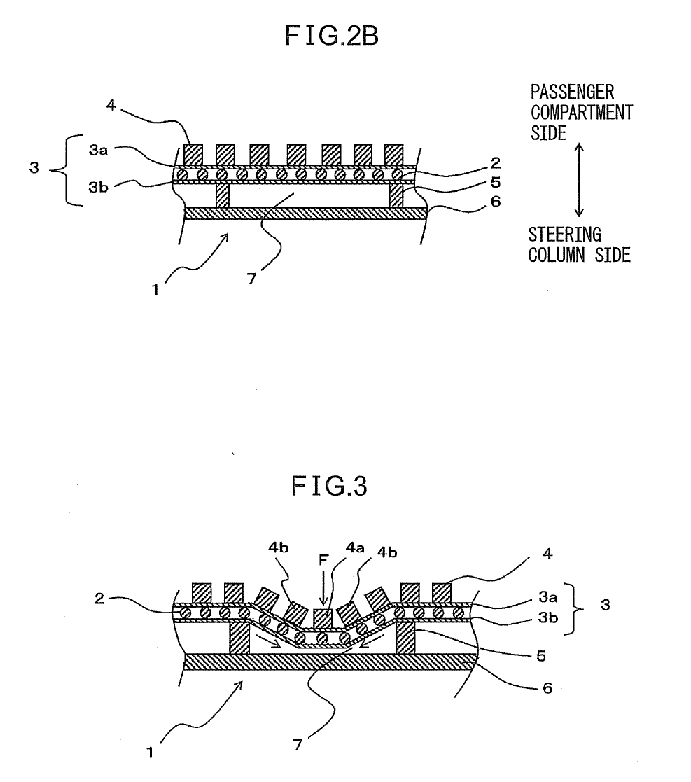

A first embodiment of the present invention will be explained based on FIG. 1 to FIG. 3. FIG. 1 is a schematic view which shows the state of attachment of a radiant heating system for vehicular use 1 according to the present embodiment to a vehicle. FIG. 2 shows part of the radiant heating system for vehicular use 1 according to the present embodiment, FIG. 2A is a plan view, and FIG. 2B is a cross-sectional view along the line I-I of FIG. 2A. FIG. 3 is a cross-sectional view which shows the state of the radiant heating system for vehicular use 1 according to the present embodiment being pushed. Note that, the arrows in FIG. 1 show the top, bottom, front, and back of the vehicle.

The vehicle of the present embodiment is provided with not only a radiant heating system for vehicular use 1, but also a not shown heating system using the engine cooling water as the heat source to heat the inside of the passenger compartment. Therefore, the radiant heating system for vehicular use 1 of the present embodiment is used as an auxiliary heat system which is started up when sufficient heat for heating the inside of the passenger compartment cannot be obtained from the engine cooling water such as at the time of engine startup and which provides immediate heating around the legs of the driver etc. shown by the two-dot chain line of FIG. 1.

As shown in FIG. 1, the radiant heating system for vehicular use 1 is attached to an interior member forming the inside surface of the passenger compartment. Specifically, to efficiently heat the legs of the driver, it is attached by screws etc. to the bottom surface of a steering column 6 right above the legs of the driver. Note that, in FIG. 1, to clarify the mounting position in the vehicle of the radiant heating system for vehicular use 1, a steering wheel 8 and seat 9 etc. are also shown.

The radiant heating system for vehicular use 1, as shown in FIGS. 2A and 2B, is provided with a heating means comprised of an electric heater 2, a protective member 3 which prevents the driver from contacting the electric heater 2, and supporting members 5 which support the protective member 3.

The electric heater 2 has a nichrome wire as a heat generating member which generates heat upon being supplied with current. This nichrome wire is bent several times in a snaking manner on the same surface. Further, the electric heater 2 is supplied with power from a not shown battery through a not shown switch means.

Further, the present embodiment has a pair of sheet-shaped members 3a and 3b made of silicone rubber which has pliability. The electric heater 2 is provided between this pair of sheet-shaped members 3a and 3b. Among the pair of sheet-shaped members 3a and 3b, the sheet-shaped member 3a which is provided at the passenger compartment side from the electric heater 2 performs the role of preventing the driver etc. from contacting the electric heater 2. Therefore, this sheet-shaped member 3a forms the protective member of the present invention.

The front surface of this sheet-shaped member 3a has a plurality of projecting members 4 bonded to it which stick out toward the passenger compartment side. These are provided at fixed intervals on the front surface of the sheet-shaped member 3a. The projecting members 4 are made from foamed silicone rubber and configured as block shapes. Their thickness is greater than the sheet-shaped member 3a. The projecting members 4 are set so that the temperature of the contacting parts of the skin of the driver or passenger and the protective member 3 becomes no more than 333K (60° C.) at the time of stable contact. Note that, “at the time of stable contact” means the state when transfer of heat between the skin of the driver etc. and the protective member 3 is balanced and the temperature of the contact parts is stable.

Specifically, when the overall heat transfer coefficient of the protective member 3 is K′ [W/(m²·K)], the overall heat transfer coefficient of the human body is K4 [W/(m²·K)], the blood flow temperature of the human body at normal times is Tm [K], and the surface temperature of the electric heater 2 is Th [K], the overall heat transfer coefficient K′ of the protective member 3 is set to satisfy the relationship shown by the following formula:

(2×Th×K′+Tm×K4)/(2×K′+K4)≦333

As shown in FIG. 2, a plurality of supporting members 5 are provided at any positions between the sheet-shaped member 3b and the steering column 6. These supporting members 5 are formed by a material which is harder than the sheet-shaped members 3a and 3b. The supporting members 5 support the electric heater 2, sheet-shaped member 3a, sheet-shaped member 3b, and projecting members 4 from the steering column 6 side. Due to this configuration, an air space 7 is formed between the sheet-shaped member 3b and the steering column 6.

Actions and Effects of Present Embodiment

According to the present embodiment, the surface of the sheet-shaped member 3a at the inside of the passenger compartment is provided with a plurality of projecting members 4, so the heat of the electric heater 2 is radiated from the surface of the sheet-shaped member 3a between projecting members 4 to the inside of the passenger compartment.

If the driver etc. pushes against a certain specific projecting member 4a by his or her fingers, the sheet-shaped members 3a and 3b are acted on by a force F in the pushing direction. Here, the supporting members 5 are formed by a material which is harder than the sheet-shaped members 3a and 3b, so the sheet-shaped members 3a and 3b at the inside from the supporting members 5 bend in the pushing direction. Due to this, the projecting members 4b adjoining the pushed projecting member 4a tilt to the pushed projecting member 4a side. Due to this, the distances between the front end of the pushed projecting member 4a and the front ends of the adjoining projecting members 4b become smaller and it becomes harder for the fingers of the driver etc. to touch the sheet-shaped member 3a raised in temperature.

Due to such an action, in the state where the driver etc. does not contact the projecting members 4, the radiant heat which is generated from the electric heater 2 can prevent a drop in the feeling of warmth of the driver or passengers. Even if the driver etc. touches a projecting member 4 by his or her fingers, it is difficult for his or her fingers to contact the sheet-shaped member 3a raised in temperature and therefore possible to prevent burns.

### Second Embodiment

Configuration of Present Embodiment

A second embodiment of the present invention will be explained next. In the present embodiment, the points different from the first embodiment will be explained.

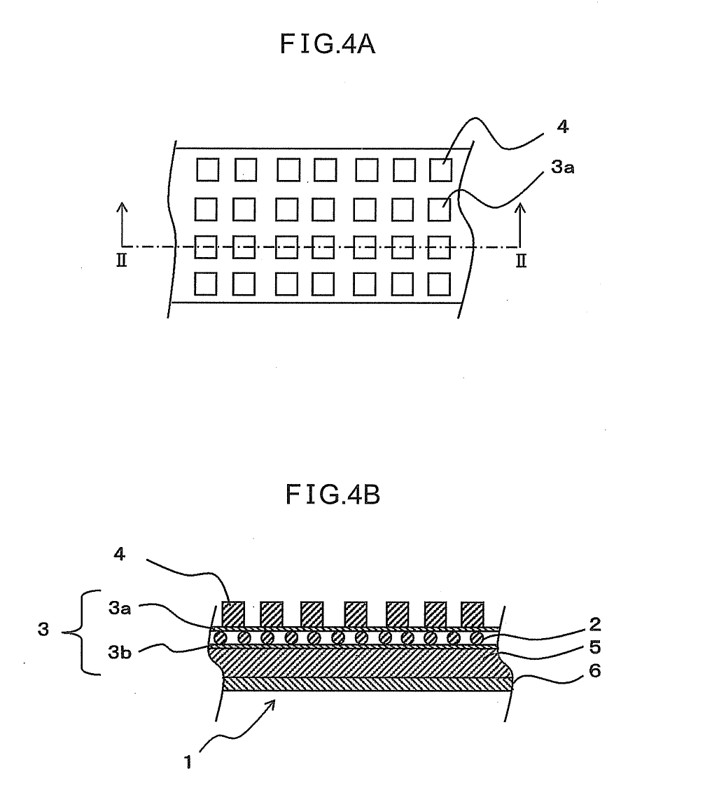

Parts the same as in the first embodiment are assigned the same reference numerals and explanations are omitted. FIGS. 4A and 4B show part of a radiant heating system for vehicular use 1 according to the second embodiment, wherein FIG. 4A is a plan view and FIG. 4B is a cross-sectional view along the line II-II of FIG. 4A.

As shown in FIG. 4B, a supporting member 5 which has pliability is provided so as to fill the space between the sheet-shaped member 3b and the steering column 6. This supporting member 5 is used to support the sheet-shaped member 3b from the steering column 6 side. Therefore, in the present embodiment, no air space 7 is formed like in the first embodiment.

Actions and Effects of Embodiment

According to the present embodiment, the front surface of the sheet-shaped member 3a at the passenger compartment side is provided with a plurality of projecting members 4, so heat from the electric heater 2 is radiated into the passenger compartment from the front surface of the sheet-shaped member 3a between projecting members 4.

On the other hand, if the driver etc. touches a certain specific projecting member 4 with his or her finger, the sheet-shaped members 3a and 3b and supporting member 5 are acted on by a force F in the pushing direction whereby the sheet-shaped members 3a and 3b and supporting member 5 flex in this pushing direction. Due to this, the projecting members 4 which adjoin the pushed projecting member 4 tilt to the pushed projecting member 4 side. Due to this, the distances between the front end of the pushed projecting member 4 and the front ends of the adjoining projecting members 4 become smaller and it becomes harder for the fingers of the driver etc. to touch the sheet-shaped member 3a raised in temperature.

Due to such an action, advantageous effects similar to those of the first embodiment can be exhibited.

### Other Embodiments

The present invention is not limited to the above embodiments and can be modified in various ways as follows within a range not exceeding the gist of the present invention.

(1) In the first embodiment and second embodiment, the sheet-shaped members 3a and 3b are configured in flat shapes, but may also be curved shapes sticking out to the passenger compartment side. By adopting such a configuration, the front ends of the plurality of projecting members 4 spread out in fan shapes, so the heat which is radiated from the sheet-shaped member 3a becomes harder to block by the projecting members 4 and therefore the heating ability inside the passenger compartment can be improved.

(2) Conversely, the sheet-shaped members 3a and 3b may be made curved shapes recessed to the steering column 6 side.

(3) In the first embodiment and second embodiment, the sheet-shaped member 3a has the projecting members 4 bonded to it, but the sheet-shaped member 3a and the projecting members 4 may also be formed integrally.

(4) In the first embodiment and second embodiment, the projecting members 4 are made block shapes, but they may also be made cylindrical shapes.

(5) In the first embodiment and second embodiment, the electric heater 2 is provided between the pair of sheet-shaped members 3a and 3b, but it is also possible to provide a single sheet-shaped member and embed an electric heater inside the sheet-shaped member.

(6) The projecting members 4 may also be made two-layer structures. Specifically, the part (bottom layer) which abuts against the sheet-shaped member 3a may be made from a heat resistant material, while the part which is provided on the bottom layer (top layer) may be made from a material relatively weaker against heat compared with the bottom layer. By employing such a configuration, it is possible to reduce the amount of the costly heat resistant material and thereby cut costs.

(7) The projecting members 4 may also be arranged in a zigzag manner.

(8) The distances between adjoining projecting members 4 may also be arranged so as to become smaller than the widths of the projecting members.

While the invention has been described by reference to specific embodiments chosen for purposes of illustration, it should be apparent that numerous modifications could be made thereto by those skilled in the art without departing from the basic concept and scope of the invention.

1. A radiant heating system for vehicular use which is attached to an interior member which forms an inside surface of a passenger compartment, the radiant heating system for vehicular use comprising:
a heating means for generating radiant heat;
a protective member which is arranged at a passenger compartment side from the heating means and which prevents a driver etc. from contacting the heating means; and
supporting members which support a location of the protective member at an opposite side from the inside of the passenger compartment, wherein
the front surface of the protective member at the passenger compartment side is provided with a plurality of projecting members,
the protective member has pliability,
the supporting members are provided so as to form an air space at an opposite side of the protective member from the passenger compartment side, and
the protective member flexes in a pushed direction when the driver etc. pushes against one of the projecting members, projecting members which adjoin the pushed projecting member tilt to the pushed projecting member side, and the distances between the front end of the pushed projecting member and the front ends of the adjoining projecting members become smaller.

2. A radiant heating system for vehicular use which is attached to an interior member which forms an inside surface of a passenger compartment, the radiant heating system for vehicular use comprising:
a heating means for generating radiant heat;
a protective member which is arranged at a passenger compartment side from the heating means and which prevents a driver etc. from contacting the heating means; and
a supporting member which supports a location of the protective member at an opposite side from the inside of the passenger compartment, wherein
the front surface of the protective member at the passenger compartment side is provided with a plurality of projecting members,
the protective member and supporting member have pliability, and
the protective member and the supporting member flex in a pushed direction when the driver etc. pushes against one of the projecting members, projecting members which adjoin the pushed projecting member tilts to the pushed projecting member side, and the distances between the front end of the pushed projecting member and the front ends of the adjoining projecting members become smaller.

3. A radiant heating system for vehicular use as set forth in claim 1, comprising a pair of sheet-shaped members which have pliability,
the protective member is comprised of one of the pair of sheet-shaped members,
a front surface of this one sheet-shaped member is provided with said projecting members, and
the heating means is provided between the pair of sheet-shaped members.
